(19) United States
(12) Patent Application Publication
(10) Pub. No.: US 2022/0241054 A1
(43) Pub. Date: Aug. 4, 2022

(54) ORTHODONTIC APPLIANCE

(71) Applicant: Jeffrey Seymour, Tampa, FL (US)

(72) Inventor: Jeffrey Seymour, Tampa, FL (US)

(21) Appl. No.: 17/589,013

(22) Filed: Jan. 31, 2022

Related U.S. Application Data
(60) Provisional application No. 63/144,703, filed on Feb. 2, 2021.

(51) Int. Cl. A61C 7/08

(52) U.S. Cl. CPC A61C 7/08

(57) ABSTRACT

An orthodontic appliance includes a structural backbone shaped to conform to a cemento-enamel junction of a patient and a plurality of elastically-deformable stirrups connected to the structural backbone. Each stirrup has a neutral shape corresponding to a desired position for a respective tooth. The stirrups engage the teeth such that restorative forces arising in the stirrup it is deformed from the neutral shape are transmitted to the respective tooth of the patient. The plurality of stirrups are not interconnected with each other except along the structural backbone. The orthodontic appliance in its entirety can be formed through 3D printing or other additive manufacturing techniques or, alternatively, by removing material from a more conventional tray-style aligner.

### CROSS-REFERENCE TO RELATED APPLICATIONS

This application claims the benefit of U.S. provisional application No. 63/144,703, filed 2 Feb. 2021, which is hereby incorporated by reference as though fully set forth herein.

### BACKGROUND

The present disclosure relates generally to orthodontic appliances. In particular, the present disclosure relates to orthodontic appliances for repositioning teeth.

Orthodontic treatment of malocclusion with a series of clear plastic trays, or aligners, has become more popular among consumers and more widely accepted within the profession over the past several years. Such treatment is generally considered more esthetic for the patient. Aligners are also removable, which makes it easier to clean both the appliance and the patient's mouth.

On the other hand, compared to traditional brackets and wires (that is, conventional orthodontic therapy), aligners are less efficient and less effective. For example, aligners inherently lack flexibility in certain dimensions or directions. This means that aligner deformation is minimal, which in turn enables only small movements per tray. Indeed, each tray may only move the teeth on the order of about 0.1 mm toward the final result. Moreover, each small movement must occur precisely, or it will render successive trays less effective.

As another example, a patient's teeth are often fitted with attachments, or bonded pieces of composite, to aid the aligner in attaching to and moving the teeth. Patients, however, may find such attachments undesirable insofar as they reduce the “invisibility” of the aligner. They are also prone to breakage, necessitating additional office visits to repair.

### BRIEF SUMMARY

Disclosed herein is an orthodontic appliance, including: a structural backbone shaped to conform to a cemento-enamel junction of a patient; and a plurality of elastically-deformable stirrups connected to the structural backbone. Each elastically-deformable stirrup has a neutral shape corresponding to a desired position for a respective tooth of the patient. Each elastically-deformable stirrup also includes a first wall to engage a front surface of a tooth and a second wall to engage a back surface of a tooth, such that restorative forces arising in the elastically-deformable stirrup when the elastically-deformable stirrup is deformed from the neutral shape are transmitted to the respective tooth of the patient. The plurality of elastically-deformable stirrups are not interconnected with each other except along the structural backbone.

According to embodiments of the disclosure, at least one elastically-deformable stirrup of the plurality of elastically-deformable stirrups is integrally formed with the structural backbone. For example, the orthodontic appliance in its entirety can be formed through 3D printing or other additive manufacturing techniques. Alternatively, the orthodontic appliance can be formed by removing material from a more conventional tray-style aligner.

In other embodiments of the disclosure, the at least one elastically-deformable stirrup of the plurality of elastically-deformable stirrups is interchangeably connected to the structural backbone. Thus, for example, stirrups can be interchanged during a course of treatment, with each stirrup providing an incremental adjustment to the position of the respective tooth.

The first wall of at least one elastically-deformable stirrup of the plurality of elastically-deformable stirrups can include an aperture therethrough. To facilitate attachment between the appliance and the teeth, a practitioner or patient can apply a suitable removable adhesive, such as dental silicone, through the aperture(s).

Certain aspects of the disclosure utilize a rigid structural backbone. Other aspects of the disclosure utilize a plastically-deformable structural backbone. Still further aspects of the disclosure utilize an elastically-deformable structural backbone (e.g., a structural backbone that includes a shape memory material).

It is also contemplated that at least one elastically-deformable stirrup of the plurality of elastically-deformable stirrups may include a shape memory material, thus allowing a practitioner to adjust the shape of the stirrup during a course of treatment.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 illustrates an orthodontic appliance according to embodiments disclosed herein.

FIGS. 2A and 2B illustrate a stirrup according to aspects of the instant disclosure.

While multiple embodiments are disclosed, still other embodiments of the present disclosure will become apparent to those skilled in the art from the following detailed description, which shows and describes illustrative embodiments. Accordingly, the drawings and detailed description are to be regarded as illustrative in nature and not restrictive.

### DETAILED DESCRIPTION

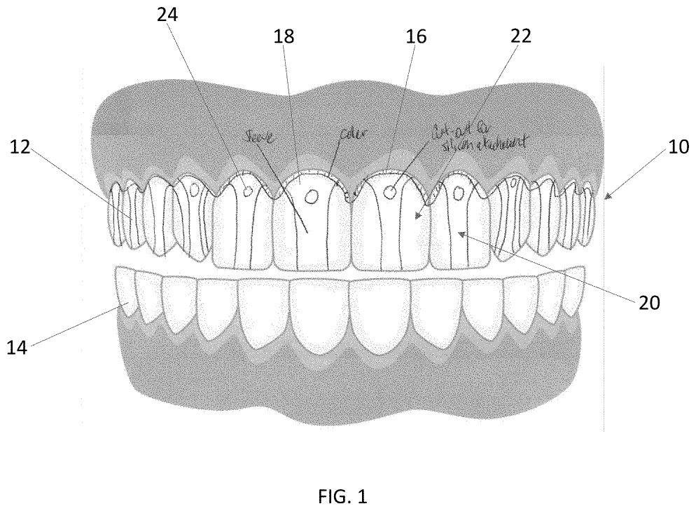

FIG. 1 depicts an orthodontic appliance 10, as worn on upper teeth 12. Those of ordinary skill in the art will appreciate that the teachings herein apply equally to an orthodontic appliance for wear on lower teeth 14.

For purposes of explanation, embodiments of the disclosure will be described with reference to a single orthodontic appliance 10, usable for a given increment of treatment. Those of ordinary skill in the art will appreciate that the teachings herein extend to successive orthodontic appliances 10 as used in a particular course of treatment.

Orthodontic appliance 10 includes a structural backbone 16 that is shaped to conform generally to the patient's cemento-enamel junction (“CEJ”). In embodiments of the disclosure, structural backbone 16 is relatively rigid (that is, capable of only minimal deformation without breakage). Among other advantages, this provides strength to orthodontic appliance 10 and facilitates retention of orthodontic appliance 10 on teeth 12, 14.

In other embodiments of the disclosure, structural backbone 16 may be more flexible, and therefore capable of more substantial deformation without breakage. For instance, structural backbone 16 may be plastically deformable, permitting a practitioner to shape and/or reshape structural backbone into a desired configuration for treatment.

Alternatively, structural backbone 16 may be elastically deformable, such that, when deformed, forces arise in structural backbone 16 that act to restore structural backbone 16 to a neutral shape. As the ordinarily-skilled artisan will recognize, these restorative forces can be leveraged to adjust the position of teeth 12, 14; they can also aid in retention of orthodontic appliance 10 on teeth 12, 14. It is contemplated that structural backbone 16 may be made elastically deformable through the use of a shape memory material.

Orthodontic appliance 10 further includes a plurality of stirrups 18 connected to structural backbone 16, with each stirrup 18 corresponding to a respective tooth 12, 14. Of course, it should be understood that, depending on a patient's treatment needs, not every tooth 12, 14 may have a corresponding stirrup 18 (e.g., some teeth may not require adjustment).

Likewise, it may be desirable to utilize multiple stirrups 18 for certain teeth. For example, two stirrups 18 (or a stirrup with a Y-shaped split) may be used for canine teeth in order to engage both aspects of the angled incisal surface.

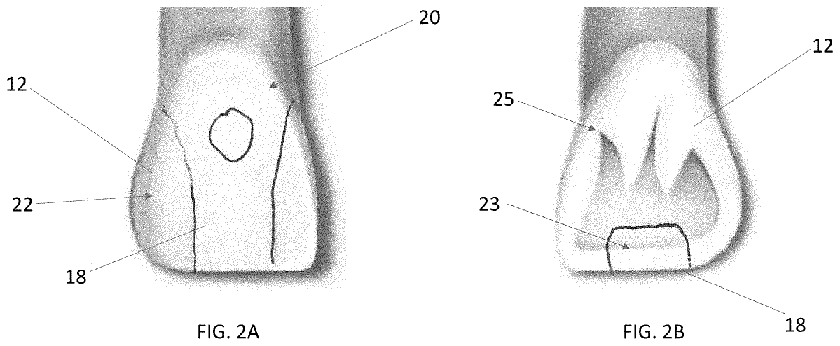

As shown to good advantage in FIGS. 2A and 2B, each stirrup 18 includes a first wall 20 to engage a front (e.g., facial) surface 22 of a tooth 12, 14 and a second wall 23 to engage a rear (e.g., lingual) surface 25 of a tooth 12, 14. The first and second walls of some or all stirrups 18 may be connected across the incisal/occlusal surfaces of teeth 12, 14 (e.g., as a single continuous piece of material), though this is not necessary.

FIG. 2B illustrates that second wall 23 need not extend all the way up the lingual surface 25 of tooth 12, 14, and can instead be in the nature of a “clip” that extends only a short distance. One advantage of the configuration shown in FIG. 2B is that second wall 23 may engage with the marginal ridge and thereby improve retention of orthodontic appliance 10.

It is contemplated, however, that both first wall 20 and second wall 23 may extend along all, or substantially all, of respective surfaces 22, 25. It is likewise contemplated that the configuration of FIGS. 2A and 2B may be reversed—that is, with second wall 23 being taller than first wall 20, which has the aesthetic advantage of minimizing the portion of orthodontic appliance 10 visible to others.

Each stirrup 18 is elastically deformable, with a neutral shape that corresponds to a desired position for the underlying tooth 12, 14 (e.g., to a particular increment of adjustment intended to be achieved by a given orthodontic appliance 10). In certain embodiments of the disclosure, stirrups 18 may incorporate a shape memory material.

It should be understood that the widths of stirrups 18 as shown in the Figures are merely illustrative. Indeed, the width of any particular stirrup 18 may be adjusted as necessary or desirable in order to balance flexibility of stirrup 18, and thereby the increment of adjustment intended to be achieved by a given orthodontic appliance 10, with the overall structural rigidity of orthodontic appliance 10.

During treatment, engaging the first and second walls of stirrup 18 with a tooth 12, 14 will deform stirrup 18. This gives rise to restorative forces, which are in turn transmitted to the underlying tooth 12, 14. Over time, therefore, the underlying tooth 12, 14 will change its position to the neutral shape of stirrup 18.

Stirrups 18 are not interconnected with each other except along structural backbone 16. That is, it is structural backbone that joins stirrups 18 into a single orthodontic appliance 10. This allows orthodontic appliance 10 to achieve a higher degree of flexibility than conventional aligner trays. In other words, permitting each tooth 12, 14 to move individually permits appliance 10 to achieve a greater degree of adjustment than can be achieved with a conventional aligner—in some instances, a single appliance 10 according to the instant disclosure may be able to achieve the same degree of adjustment as about five to ten conventional aligners.

Moreover, the higher degree of deformation achievable with stirrups 18, and the concomitant increased frictional engagement between stirrups 18 and teeth 12, 14, reduces, and may eliminate, the need for dedicated structures to secure orthodontic appliance 10 to teeth 12, 14. It is contemplated, however, that engagement between stirrup 18 and the underlying tooth 12, 14, the retention of appliance 10 on teeth 12, 14, and thus the transmission of restorative forces therebetween, can also be enhanced by applying a biocompatible adhesive, such as dental silicone, through apertures 24 in stirrups 18. The use of a biocompatible adhesive may be particularly desirable as teeth 12, 14, near their final position for a given orthodontic appliance 10, when the deformation of stirrups 18, and therefore the amount of friction between stirrups 18 and teeth 12, 14, is lowest. Advantageously, in any event, this enhanced engagement can be achieved without an office visit, with the patient applying and reapplying the adhesive on an as-needed basis.

It is contemplated that orthodontic structural backbone 16 and stirrups 18 can be integrally formed. For example, 3D printing or other additive manufacturing techniques may be used to form orthodontic appliance 10 as an integral unit. As another example, molding techniques may be used to form orthodontic appliance 10 as an integral unit. Other suitable manufacturing techniques will be familiar to those of ordinary skill in the art.

Alternatively, structural backbone 16 and stirrups 18 can be separately formed, with stirrups 18 attached to structural backbone 16 through a suitable fastening mechanism or adhesive.

Separately forming structural backbone 16 and stirrups 18 may further facilitate interchangeability of stirrups 18. That is, rather than using a series of integral appliances for successive stages of treatment, a practitioner can instead remove, adjust, and/or swap out stirrups 18 for successive stages of treatment.

Indeed, in other aspects of the disclosure, stirrups 18 may be interconnected without the use of a structural backbone 16. For example, a plurality of stirrups 18 may be formed (e.g., by additive manufacturing, molding, or another suitable technique) and then connected to each other by a suitable adhesive or other fastener, such as a small screw.

Those of ordinary skill in the art will be familiar with suitable biocompatible materials for orthodontic appliance 10. By way of illustration only, however, various thermoplastics and other polymers may be used in the manufacture of orthodontic appliance 10.

Although several embodiments have been described above with a certain degree of particularity, those skilled in the art could make numerous alterations to the disclosed embodiments without departing from the spirit or scope of this invention.

For example, during a course of treatment, it is contemplated that a patient may utilize a succession of appliances 10, with each appliance 10 having stirrups 18 configured to achieve a particular increment of adjustment of teeth 12, 14. It is also contemplated that, for each increment of adjustment of teeth 12, 14, multiple identical appliances 10 may be provided to the patient, for use in a manner similar to daily wear, disposable contact lenses.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

1. An orthodontic appliance, comprising:
a structural backbone shaped to conform to a cemento-enamel junction of a patient; and
a plurality of elastically-deformable stirrups connected to the structural backbone, wherein:
each elastically-deformable stirrup has a neutral shape corresponding to a desired position for a respective tooth of the patient; and
each elastically-deformable stirrup comprises a first wall to engage a front surface of a tooth and a second wall to engage a back surface of a tooth, such that restorative forces arising in the elastically-deformable stirrup when the elastically-deformable stirrup is deformed from the neutral shape are transmitted to the respective tooth of the patient; and
wherein the plurality of elastically-deformable stirrups are not interconnected with each other except along the structural backbone.

2. The orthodontic appliance according to claim 1, wherein at least one elastically-deformable stirrup of the plurality of elastically-deformable stirrups is integrally formed with the structural backbone.

3. The orthodontic appliance according to claim 1, wherein at least one elastically-deformable stirrup of the plurality of elastically-deformable stirrups is interchangeably connected to the structural backbone.

4. The orthodontic appliance according to claim 1, wherein the first wall of at least one elastically-deformable stirrup of the plurality of elastically-deformable stirrups includes an aperture therethrough.

5. The orthodontic appliance according to claim 1, wherein the structural backbone is rigid.

6. The orthodontic appliance according to claim 1, wherein the structural backbone is plastically deformable.

7. The orthodontic appliance according to claim 1, wherein the structural backbone is elastically deformable.

8. The orthodontic appliance according to claim 7, wherein the structural backbone comprises a shape memory material.

9. The orthodontic appliance according to claim 1, wherein at least one elastically-deformable stirrup of the plurality of elastically-deformable stirrups comprises a shape memory material.

10. A method of manufacturing an orthodontic appliance for adjusting one or more teeth of a patient from an initial position to an adjusted position corresponding to an increment of treatment, the method comprising:
forming a structural backbone shaped to conform to a cemento-enamel junction of the patient; and
forming a plurality of elastically-deformable stirrups connected to the structural backbone, wherein:
each elastically-deformable stirrup has a neutral shape corresponding to the adjusted position for a respective tooth of the one or more teeth of the patient; and
each elastically-deformable stirrup comprises a first wall to engage a front surface of the respective tooth and a second wall to engage a back surface of the respective tooth, such that restorative forces arising in the elastically-deformable stirrup when the elastically-deformable stirrup is deformed from the neutral shape to a deformed shape by the respective tooth are transmitted to the respective tooth and act to adjust the respective tooth the adjusted position,
wherein the plurality of elastically-deformable stirrups are not interconnected with each other except along the structural backbone.

11. The method according to claim 10, wherein forming the plurality of elastically-deformable stirrups connected to the structural backbone comprises integrally forming the plurality of elastically deformable stirrups with the structural backbone.

12. The method according to claim 11, wherein integrally forming the plurality of elastically deformable stirrups with the structural backbone comprises integrally forming the plurality of elastically deformable stirrups and the structural backbone via additive manufacturing.

13. The method according to claim 11, wherein integrally forming the plurality of elastically deformable stirrups with the structural backbone comprises molding the plurality of elastically deformable stirrups and the structural backbone as an integral unit.

14. The method according to claim 10, wherein forming the structural backbone shaped to conform to the cemento-enamel junction of the patient comprises forming a rigid structural backbone.

15. The method according to claim 10, wherein forming the structural backbone shaped to conform to the cemento-enamel junction of the patient comprises forming a plastically-deformable structural backbone.

16. The method according to claim 10, wherein forming the structural backbone shaped to conform to the cemento-enamel junction of the patient comprises forming an elastically-deformable structural backbone.

17. A method of orthodontic treatment, comprising:
determining a plurality of adjusted positions for a respective plurality of teeth of a patient;
applying an orthodontic appliance to the plurality of teeth, the orthodontic appliance comprising:
a plurality of elastically-deformable stirrups,
wherein each elastically-deformable stirrup has a neutral shape corresponding to the adjusted position for a respective tooth of the plurality of teeth, such that restorative forces arising in the elastically-deformable stirrup when the elastically-deformable stirrup is deformed from the neutral shape to a deformed shape by the respective tooth are transmitted to the respective tooth and act to adjust the respective tooth the adjusted position, and
wherein the plurality of elastically-deformable stirrups are not interconnected with each other except along a structural backbone.

18. The method according to claim 17, further comprising:
repeating the steps of:
determining a plurality of adjusted positions for a respective plurality of teeth of a patient; and
applying an orthodontic appliance to the plurality of teeth
a plurality of times, thereby delivering a plurality of increments of adjustment to the patient.

19. The method according to claim 18, wherein delivery of each successive increment of adjustment of the plurality of increments of adjustment utilizes a unique orthodontic appliance, and wherein the neutral shapes of the plurality of elastically-deformable stirrups of the unique orthodontic appliance corresponds to the respective increment of adjustment.

20. The method according to claim 18, wherein delivery of each successive increment of adjustment of the plurality of increments of adjustment comprises adjusting the plurality of elastically-deformable stirrups of a common orthodontic appliance.

21. An orthodontic appliance, comprising:
a plurality of elastically-deformable stirrups, each elastically-deformable stirrup having a neutral shape corresponding to a desired position for a respective tooth of a patient and comprising:
a first wall to engage a front surface of the respective tooth of the patient and a second wall to engage a back surface of the respective tooth of the patient, such that restorative forces arising in the elastically-deformable stirrup when the elastically-deformable stirrup is deformed from the neutral shape by engagement with the respective tooth of the patient are transmitted to the respective tooth of the patient,
wherein the plurality of elastically-deformable stirrups are interconnected with each other such that, given a pair of adjacent elastically-deformable stirrups of the plurality of elastically-deformable stirrups:
a first portion of a first member of the pair of adjacent elastically-deformable stirrups is connected to a first portion of a second member of the pair of adjacent elastically-deformable stirrups along a structural backbone; and
a second portion of the first member of the pair of adjacent elastically-deformable stirrups is separated from a second portion of the second member of the pair of adjacent elastically-deformable stirrups.

22. The orthodontic appliance according to claim 21, wherein the structural backbone comprises an elastic material.

23. The orthodontic appliance according to claim 22, wherein the structural backbone comprises a shape memory material.

24. The orthodontic appliance according to claim 21, wherein the structural backbone comprise a plastically-deformable material.

25. The orthodontic appliance according to claim 21, wherein the structural backbone is shaped and positioned to conform to a cemento-enamel junction of the patient.
